(19) United States
(12) Patent Application Publication
(10) Pub. No.: US 2015/0060540 A1
(43) Pub. Date: Mar. 5, 2015

(54) FULLY-AUTOMATIC DIGITAL ELECTRONIC PAYMENT TRANSACTION IDENTITY AUTHENTICATION METHOD WITH HIGH SECURITY

(71) Applicants: Joe Chi CHEN, Rowland Heights, CA (US); Louis Chien CHEN, Rowland Heights, CA (US); Andrew Chien CHEN, (US)

(72) Inventor: Joe Chi CHEN, Rowland Heights, CA (US)

(73) Assignees: Joe Chi Chen, Rowland Heights, CA (US); Louis Chien Chen, Rowland Heights, CA (US); Andrew Chien Chen, Rowland Heights, CA (US)

(21) Appl. No.: 14/017,910

(22) Filed: Sep. 4, 2013

(51) Int. Cl. G06Q 20/38; G06Q 20/34; G06Q 20/26

(52) U.S. Cl. CPC G06Q 20/3821; G06Q 20/26; G06Q 20/341
USPC 235/379

(57) ABSTRACT

The present invention enables a cardholder to apply to a card issuing institution to set up a chip debit card. The card issuing institution builds a computing formula into the chip, and when the cardholder uses the chip debit card, the financial transaction system inserts relevant information from the financial transaction proceeding at that instance into the built-in formula of the chip debit card. Corresponding values produced by the computing formula are combined with hidden numerals input by the cardholder when carrying out their consumption transaction, and a dynamic combination code is derived. The dynamic combination code serves as a basis for the card issuing institution to authenticate the identity of the cardholder, thereby effectively preventing the risk of leaking, deciphering, and copying of personal information of the cardholder, and fraudulent use thereof.

### BACKGROUND OF THE INVENTION

(a) Field of the Invention

The present invention relates to electronic financial transaction payment technology, and more particularly to a fully-automatic digital electronic payment transaction identity authentication method with high security that completely eliminates the need to reveal personal information and account numbers, but is able to accurately display the correct identity of the cardholder, payment amount and payee identity, thereby effectively preventing leaking and deciphering of personal information of the cardholder, thus reducing the risk of copying of personal information and account numbers of the cardholder, or fraudulent use thereof.

(b) Description of the Prior Art

With the advancement of technology, and the rapid development of e-commerce and communication technologies, people's lifestyles and methods of financial; transactions have changed. Hence, financial companies have implemented a credit card consumption pattern, whereby there is no need for consumers to carry cash when shopping. The consumer need only take out their credit card and pass the credit card through a credit card reader set up in the store and connected to the banking company to carry out an account transaction. And as long as the consumer transfers into a bank account the amount of money spent before the date set for settlement of the account, then an after payment cash-free transaction mode is completed.

Recently, because of the numerous incidents related to the forgery and fraudulent use of traditional magnetic stripe credit cards and debit cards, there are already financial companies switching to the use of relatively higher secure integrated circuit chip cards. Apart from providing the traditional payment functions, these types of card also integrate other diverse functions including the ability to make cash withdrawals, transfer accounts, credit consumption, accumulate bonus points, and make micro payments.

When carrying out the settlement of account of consumption amount for a consumption transaction proceeding using an existing chip debit card, the end seller needs only take the chip debit card provided by the cardholder (such as credit card, cash card or debit card), and using connection authentication through a contact reader module or swipe reader module in a transaction system, or in combination with an additional input interface for entering a password, then authenticity of the identity of the cardholder can be confirmed. Moreover, the system can decide whether or not to accept the consumption transaction by the cardholder.

However, in general, the method adopted to confirm identity of the payer or the payee and the amount for current financial settlement of an account proceeding is to carry out confirmation after transmission of personal information. Thus, this results in the possibility copying and misappropriation of personal information during the course of transmission, or fraudulent use of another person's personal data to apply for credit cards, thereby leading to a lot of problems and a huge loss of money. Hence, how to design a method for settlement of financial transactions which is reliable and suitable for everyone, lowers the risk of personal information of the payer being stolen or minimizes fraudulent use thereof during a financial settlement proceeding has already become a major issue in modern times.

### SUMMARY OF THE INVENTION

A primary objective of the present invention is to provide a method that completely eliminates the need to reveal personal information and account numbers, but is able to accurately display the correct identity of the cardholder, payment amount and payee identity, thereby effectively preventing leaking and deciphering of personal information of the cardholder, thus reducing the risk of copying or fraudulent use of personal information and the account number of the cardholder.

In the present invention, the cardholder first applies to the card issuing institution for a debit card installed with a chip. A computing formula recognized and confirmed by the card issuing institution is built into the chip of each chip debit card. When the cardholder uses the chip debit card to carry out a financial transaction, a financial transactions system uses the collecting account number, payment amount, identification number for the financial transaction proceeding at that instance, and the identification card number of the cardholder of the chip debit card to serve as a dynamic source, which is fed into the computing formula built in the chip debit card. The corresponding values produced by the computing formula are then combined with the at least one set of hidden numerals input by the cardholder when making a purchase. A set of information and data from numbers including a payment account number, a collecting account number and the consumption amount are obtained for the financial transaction proceeding at that instance is converted and becomes a dynamic combination code for re-transmission. The dynamic combination code serves as a basis for the card issuing institution to authenticate the identity of the cardholder, and reduce the risk of copying and fraudulent use of personal information and the account number of the cardholder.

Furthermore, the present invention enables the cardholder at the same time to apply to set up a reserve card that is limited to transfer of accounts to the chip card debit card when applying to the card issuing institution for a debit card installed with the chip. This enables consumers to choose to deposit the major portion of their money in the reserve card, and store a limited amount of money in the chip debit card for use when they go out.

Furthermore, the present invention enables the card issuing institution to set up the chip debit card with an activation password to strengthen the function to authenticate the identity of the cardholder.

Furthermore, the present invention enables the cardholder to set the identification card number of the cardholder to automatically register in the financial transaction system every time the chip debit card is used.

Furthermore, the present invention enables the cardholder to set the identification card number of the cardholder to input anew into the financial transaction system every time the chip debit card is used.

Furthermore, the present invention enables the cardholder to set at least one characteristic of the cardholder that can be used for verification to allow a high payment limit or when a password input error occurs to implement checking and verification.

The aforementioned characteristics of the cardholder can be chosen to be at least a photo, height, weight, feature of cardholder's appearance, telephone number, or cardholder's license number.

The at least one set of hidden numerals described above can be the account number password for the chip debit card.

Specifically, the present invention primarily comprises converting the accurate information and data of payer identity and payee identity, and the transaction amount into a dynamic digital combination and re-transmitted (one-time) when a financial proceeding occurs. Thus, there is no possibility for the information and data to be copied, while still allowing for accurate identification. The method effectively transforms current financial proceedings in which there exists the risk of personal information being easily stolen or made fraudulent use of. Not only does the present invention provide low cost in use, is very easy to implement, and is extremely competitive, but also improves the shortcomings of the prior art only being able to authenticate identity.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view depicting an operating state of a first embodiment of the present invention.

FIG. 2 shows transmission of a combined portion of related codes and hidden numerals when carrying out a financial transaction proceeding (electronic check issuing) according to the present invention.

FIG. 3 represents transmission of a combined portion of related codes and hidden numerals when carrying out a financial transaction proceeding according to the present invention.

FIG. 4 shows a schematic view depicting an operating state of another embodiment of the present invention.

### DETAILED DESCRIPTION OF THE PREFERRED EMBODIMENTS

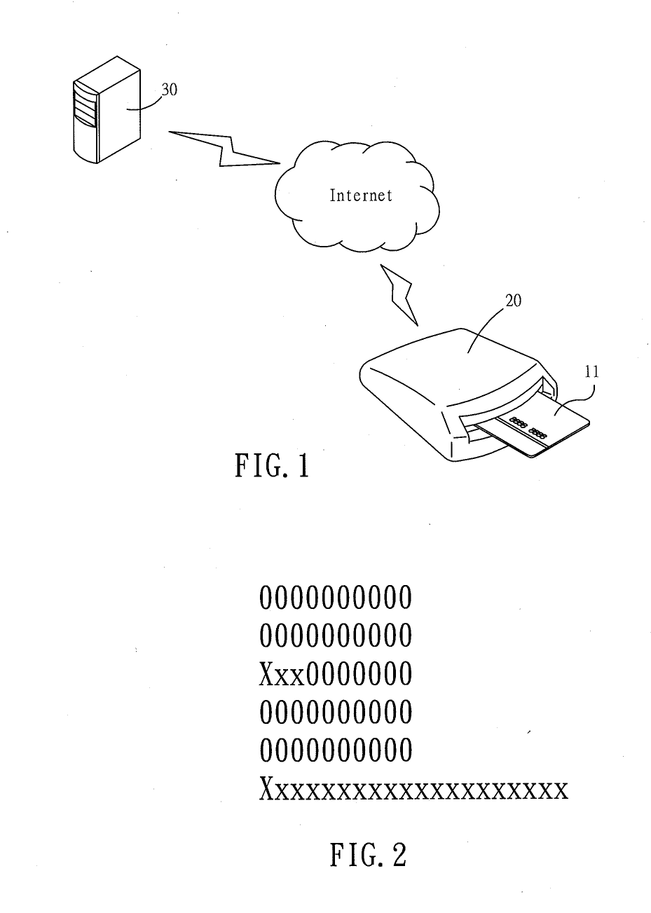

The present invention provides a fully-automatic digital electronic payment transaction identity authentication method with high security that completely eliminates the need to reveal personal information and account numbers, but is able to accurately display the correct identity of the cardholder, the payment amount and payee identity, thereby effectively preventing misappropriation of personal information of the payer, or fraudulent use thereof. The cardholder first applies to the card issuing institution for a debit card set up with a chip, and a computing formula recognized and confirmed by the card issuing institution is built into the chip of each chip debit card. When the cardholder uses the chip debit card to carry out a financial transaction, a chip debit card 11, as depicted FIG. 1, connects to a remote card issuing institution 30 (or a representative agency commissioned by the card issuing institution) through a reading module 20 provided by a financial transactions system.

When settling the account for the financial transaction proceeding at that instance, the financial transactions system inserts the collecting account number of the financial transaction proceeding at that instance, the payment amount, the identification number for the financial transaction proceeding at that instance, and the identification card number of the cardholder of the chip debit card into the computing formula built into the chip debit card 11. The corresponding value produced by the computing formula is then combined with the at least one set of hidden numerals input by the cardholder when making a purchase (at least one set of hidden numerals described above can be the account number password for the chip debit card). A dynamic combination code converted from a set of information and data, including the payment account number, collecting account number and consumption amount for the financial transaction proceeding at that instance, is then obtained converted for re-transmission. The dynamic combination code serves as a basis for the card issuing institution to authenticate the identity of the cardholder, and reduce the risk of copying personal information and the account number of the cardholder, and fraudulent use thereof.

Because the contents executed by the computation program of the chip debit card configured with the identification card number of each cardholder is different for each person, thus, only the card issuing institution is able to confirm the contents. Hence, when activating a payment, the identification card number and the configured payment account code must be absolutely correct before payment can be activated, and at the same time obtain the corresponding value, and thus provides a two-factor authentication function. Moreover, the data transfer process is presented completely by means of dynamic numerals. Accordingly, there is no problem regarding leakage of personal information. This function further prevents cardholders from committing fraudulent use of accounts of other people, and other people are unable to commit fraudulent use of accounts of cardholders. In particular, the identification card number and account number of the cardholder must be identical to the cardholder in order to obtain the correct corresponding value. Hence, the present invention is able to effectively prevent manufacturing of counterfeit cards and committing fraudulent use of personal information of other people to apply for chip debit cards.

In addition, each numerical value of the dynamic combination code, under all combination states, must produce the necessary correspondence of each numeric value of the aforementioned each set of codes (collecting account number, payment amount, identification number, and identification card number of the cardholder of the chip debit card) after dynamic combination thereof. Hence, the method is able to not only confirm the identity of the payer, but also prevents related identity of the payee and payment amount from being changed midway through the financial transaction. Because if the identity of the payee and payment amount are changed, then the resulting numeric values are bound to be incorrect, and the transaction will be certainly be prevented from passing through the payment program.

The pattern of numeric values illustrated in FIG. 2 shows transmission of a combined portion of related codes when processing a financial transaction (electronic check issuing), wherein the first string of numbers (0000000000) represents the debit card identification number on behalf of the payee; the second string of numbers (0000000000) represents the financial transaction payment amount; and the third string of numbers (Xxx0000000) represents the identification number of the financial transaction proceeding (similar to the automatic consecutive numbers of a check number), while the first, second and third numerals of the third string of numbers are payment account code numbers, which are set by the cardholder, and respectively represent a credit card, a cash card, and a checking account. The fourth string of numbers (0000000000) represents the debit card identification number of the payer; and the fifth string of numbers (0000000000) represents the payment contents, such as payment on delivery for an Internet purchase, business post-dated check, long-term installment payment, and the like. Finally, a dynamic combination corresponding value (Xxxxxxxxxxxxxxxxxxxx) is generated. From the aforementioned numbers, hidden dynamic numerical codes are produced due to changes in the check numbers, with each numerical code representing a different computing formula, resulting in producing different corresponding values of the dynamic numerical codes.

Through the different corresponding numerical values produced from different combinations of numbers of each financial transaction proceeding, only a combination of numerals is presented in completing the transmission process. In addition, the process allows for open transmission without the need for a specific transmission device such as a card reader, or smart phone to provide layer upon layer of protective measures to verify the identity and amount. Any electronic channel (such as the Internet, mobile phone, telephone, and the like) similarly provides a safe and convenient system for transmission. Moreover, the method completely safeguards privacy, and at the same time there are no restrictions on time and place of use, as well as being fast and convenient.

The hidden numerical codes, entered every time the cardholder uses the chip debit card, are provided with a password function that strengthens authentication, because, when an incorrect hidden numerical code is entered, then the dynamic combination inevitably outputs an incorrect corresponding value, at which time the card issuing institution carries out preventive measures to verify identity. At the same time the card issuing institution is able to distinguish the source of the error from the wrong dynamic combination code (such as an incorrect password, change in amount, incorrect account number, incorrect payee code), and is able to respond to the different criminal acts with commensurate active measures, and implement different responsive procedures.

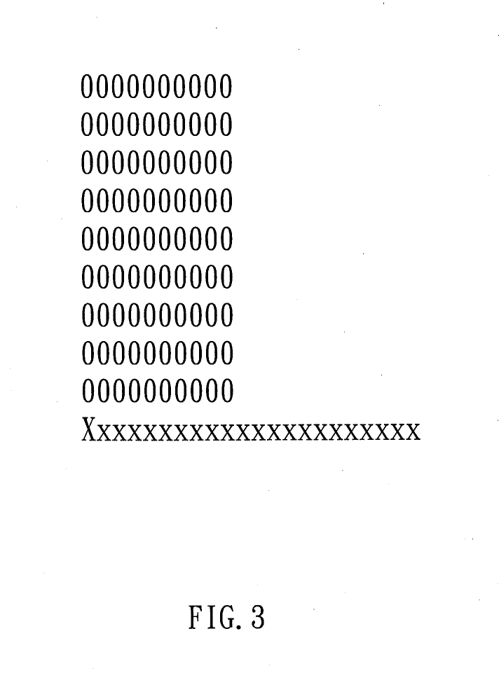

The pattern of numeric values illustrated in FIG. 3 shows transmission of related codes and a combined portion of hidden numeric codes (combined by a computation program) when processing a financial transaction proceeding (electronic check issuing), wherein the first string of numbers (0000000000) represents the three numerals of a check number, and is the payment account number code; the second string of numbers (0000000000) represents the account number of the payer (credit card, cash card, business check); the third string of numbers (0000000000) represents the payment amount; the fourth string of numbers (0000000000) represents the identification card number of the payee; the fifth string of numbers (0000000000) represents the identification card number of the payer; the sixth string of numbers (0000000000) represents characteristics of the payer inputting the numbers; the seventh string of numbers (0000000000) represents the identification data like driving number or identification card number of the payer inputting the numbers; the eighth string of numbers (0000000000) represents the payment contents; and the ninth string of numbers (0000000000) represents the payment category. The final string of numbers (Xxxxxxxxxxxxxxxxxxxxxx) can represent a different dynamic combination corresponding value after combination of the aforementioned numerals by the computation program.

Hence, the present invention provides a method that completely eliminates the need to reveal personal information and account numbers, but is able to accurately display the correct identity of the cardholder, payment amount, payee identity, and payment contents, thereby effectively preventing misappropriation or fraudulent use of personal information of the payer. According to the authentication method described, the cardholder first applies to the card issuing institution for a debit card set up with a chip, and a dynamic computing formula set up by the card issuing institution is built into the chip of each chip debit card. When the cardholder uses the chip debit card to carry out a financial transaction, as shown in FIG. 2, because changes in the debit card identification number causes changes in other numerals to occur, and changes in the numerals brings about changes in the computing formula, while changes in the computing formula results in dynamic corresponding dynamic values, thereby completing the so-called signing and issuing of an electronic check.

Furthermore, during a financial transaction proceeding at a certain time, the chip of the chip debit card inputs the hidden portion, including the collecting account number of the financial transaction proceeding at that instance, the payment amount, the debit card financial transaction number, the payment contents, and the identification card number of the debit card holder for computational combination. As shown in FIG. 3, in conjunction with the payment account number of the cardholder, and identification data, computational combination thereon is carried out to produce a corresponding dynamic value for re-transmission. The dynamic combination code serves as a basis for the card issuing institution to authenticate the identity and payment contents. and eliminate the risk of copying personal information and the account number of the cardholder, and fraudulent use thereof.

In principle, the present invention enables the cardholder to set up a contractual transaction payment, such as payment on delivery for an Internet purchase, business post-dated check payment and other contractual payments. Furthermore, the present invention enables the cardholder to use any transmission tool to transmit the dynamic numerical code (electronic check issuing). There is no need for a specific channel, because an incorrect corresponding value is produced as soon as the dynamic numerical code has been changed, thereby making it impossible to complete a transaction proceeding. Each process is provided with a multi-layered reciprocal validation function, such as providing the account number, and debit card identification number with a password function. Input of the account number is further provided with a reciprocal validation function, the payment amount is provided with a validate correct payment function, and the payee account number is provided with the function to confirm whether the payment target is error-free. Thus, the present invention possesses multi-layer authentication functions, and differs from the prior art which only provides single-track authentication methods, with the inherent risks resulting therefrom. The present invention further enables the cardholder to set up a limited payment amount and small amount payments, and also enables the cardholder to set up the need to input a password for large payment amounts, or choose to reveal the characteristics of the cardholder to use as additional verification.

In addition, the present invention can be further provided with multi-layer authentication functions, such as authentication of the payee identity and the payer identity, payment amount, and payment contents, thus improving current debit cards which only provide identity authentication. Functions that expand use for financial proceedings can also be provided, such as business checks used in the current market, cash cards, credit cards, post-dated checks, and payment on delivery for Internet purchases. The present invention improves security, convenience, and speed of financial transactions, cuts down on operating costs for banks, and integrates into a single body all current functions enabling payment for financial proceedings. The present invention has all of the functions of existing checks used for making payments.

Because of the chip configured with the debit card identification number of each holder, thus, the contents executed by the computation program is different for each person, and only the card issuing institution is able to confirm the contents (based on the debit card identification number). Hence, when activating a payment, the identification card number, the payment account and the chip contents must be absolutely correct before payment can be activated. At the same time, the correct corresponding value must be obtained, thereby providing a two-factor authentication function. Moreover, the data transfer process is presented completely by means of dynamic numerals. Accordingly, there is no problem regarding leakage of personal information. This function further prevents cardholders from committing fraudulent use of the account numbers of other people, and other people are unable to commit fraudulent use of account numbers of cardholders. In particular, the identification card number and the account number of the debit card of the cardholder must be identical to the cardholder in order to obtain the correct corresponding values. Hence, the present invention effectively prevents manufacturing of counterfeit cards and committing fraudulent use of personal information of other people to apply for chip debit cards.

The financial transactions system represents the information, including the payee account number, the payment amount, the debit card identification number of the payer, identification number, the payment contents, and the hidden payment account number, and identification data for the financial transaction proceeding at that instance, by ten digit numbers for each individual occurrence, and changes in each number, brings about changes in the built-in computing formula, resulting in producing dynamic digital corresponding values. The information for the financial transaction at that instance and the dynamic combination code produced by the corresponding values is then re-transmitted, that is, authentication is first carried out, after which transmission occurs. The card issuing institution then implements verification based on the debit card identification number of the cardholder. The method as disclosed by the present invention described differs from the prior art which adopts a method whereby the transaction information is first transmitted through a card reader, and a dynamic cipher machine then implements authentication through a card issuing institution, which provides opportunities for Internet hackers or persons with intention to misappropriate the information to commit fraudulent use thereof.

When the cardholder carries out receipt of payment or payment of account, transfer of funds can be carried out instantly with the same speed as circulation of cash, providing convenience of use, and at the same time 24-hour application, thereby transforming security and convenience of cash flow. Moreover, when the cardholder is carrying out a financial transaction, the required amount, the account number, payee, identification data and payment content are inputted and transformed into a stable dynamic digital code, which generates a dynamic computation program that produces the multifunctional identification and content authentication of dynamic corresponding values. Such a method transforms the current paper check into an electronic check, which not only provides the full functionality of current financial transaction proceedings, but also provides the key factors of speed, convenience, and security to transform current financial transaction proceedings and enable the cardholder to carry out electronic transfer transactions (at the same time applicable for use with credit cards, making remittances, for business checks, and making cash payments).

The card issuing institution is able to register the debit card identification number configured by different compiled chip computation processes, and the account number having the same name as that belonging to the cardholder (including a credit card, cash card, debit card, checking account) that the cardholders wants to use within the debit card chip, thereby producing multilateral reciprocal validation functions, and providing instant and automatic validation functions every time a financial transaction is carried out. These functions differ from the validation function through use of a card reader of credit cards of the prior art, and the troublesome operation of having to validate the transaction on every use.

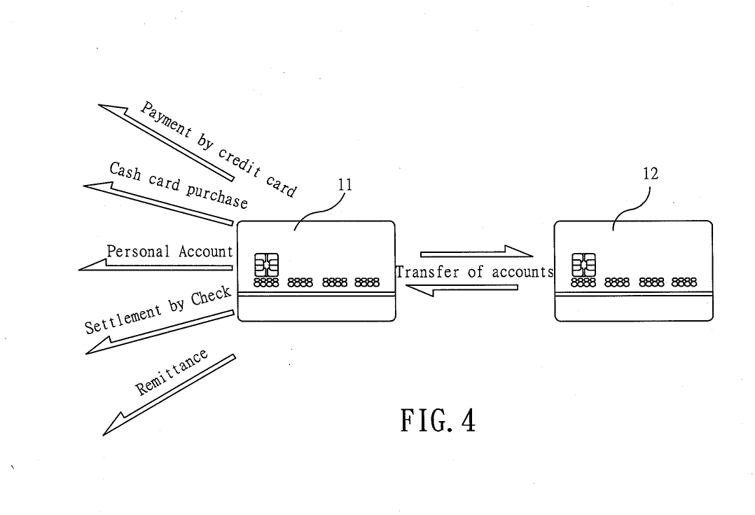

The present invention enables the cardholder to apply to the card issuing financial institution to set up the chip debit card, and at the same time apply to set up a reserve card. Referring to FIG. 4, a reserve card 12 has been limited to only being able to transfer accounts to the chip debit card 11 (of course, the chip debit card 11 can also be further provided with a function to transfer accounts to the reserve card 12), thereby enabling the consumer to choose to deposit the major portion of their money in the reserve card 12, and store a limited amount of money in the chip debit card 11 for use when the consumer goes out. When the amount required for a financial transaction proceeding is insufficient, then money can be immediately transferred from the reserve card 12 to the chip debit card 11.

Regardless of whether the cardholder also applies for a reserve card when applying to the card issuing institution for a debit card set up with the chip, when the debit card has been put into effect, the present invention enables the debit card to further comprise the following protective measures:

(1) Enable the further setting up of an activation password from the card issuing institution to strengthen the function to authenticate the identity of the cardholder.

(2) Enable the cardholder to set the identification card number of the cardholder so that it automatically displays in the financial transaction system every time the chip debit card is used, or enables the cardholder to set the identification card number of the cardholder, so that it is re-inputted into the financial transaction system every time the chip debit card is used.

(3) Enable the cardholder to set up characteristics of the cardholder that can be used to verify at least a high payment limit or when a password input error occurs. The aforementioned characteristics of the cardholder can be chosen to be at least a photograph, height, weight, feature of cardholder's appearance, telephone number, or cardholder's license number.

It is understood that the debit card can also be set up with two levels of limited amounts of payment. When making a small payment, one of the aforementioned safety measures can be chosen. When making a large payment, two or more than two of the aforementioned security measures can be chosen in order to decrease the probability of misappropriation and reduce loss of money.

Compared to the prior art, the fully-automatic digital electronic payment transaction identity authentication method with high security disclosed in the present invention is able to produce the following effects:

(1) Authentication of identification of the cardholder has a multiple layer authentication process (for example: the identification card number and the account number of the cardholder must be the same person, this is matched with the password setting and verification of the characteristics of the cardholder).

(2) All transaction information is transmitted by means of digital information representing the required data of the cardholder, and every transaction is a one-time dynamic data submission. Therefore, there is no need to set up layer upon layer of protection, and the transaction information can be openly transmitted without the possibility of any breach in security of the information being transmitted and privacy leakage. Thus, the present invention provides a broader range of use, and also provides the function of currently used checks, with the further functions of providing more secure and faster completion of credit/debit transactions.

(3) The present invention differs from the prior art, which only requires identity authentication of the cardholder. The fully-automatic digital electronic payment transaction identity authentication method with high security disclosed in the present invention is able to simultaneously confirm the identity of the payer, payee identity, the transaction amount, and other information at the instance of the financial transaction, and eliminates the possibility of the payment amount being changed, or incorrect payee identity and payer identity.

(4) The present invention differs from the prior art, which adopts a method whereby the transaction information is first transmitted, and then identity authentication is implemented. The fully-automatic digital electronic payment transaction identity authentication method with high security disclosed in the present invention is able to first complete authentication of information including the identity of the payer, payee identity and the transaction amount at the instance of the financial transaction, after which transmittance of related information is carried out. Hence, the present invention is able to reduce the risk of fraudulent use of debit cards of other persons using relatively active means.

(5) Provide high security. Because the account number (or chip debit card account number) of the cardholder is hidden and represented by an account code (code input is provided with a password function), thus, personal data can not be misappropriated to manufacture counterfeit cards. Moreover, because the identification card number of the cardholder and account number must be of the same person when activating, thus, fraudulent use of other person's personal information to apply for counterfeit cards is prevented from occurring.

(6) Minimal risk. Because the dynamic combination code inevitably outputs an incorrect corresponding value when an incorrect code or account code is entered, thus, at this time, the card issuing institution immediately carries out measures to verify identity, and initiates a function to alert the appropriator. Moreover, limitation on payment amounts are set up to further control and minimize risk of damage.

(7) Provided with the function to identify the cause of error. The card issuing institution can locate the source of errors from the corresponding values of the dynamic combination code (such as changes in amount, incorrect password, incorrect account number code, incorrect identification card number of the cardholder, or someone has indiscriminately made up the numerical codes with the intention of fraudulent use thereof).

(8) When the card issuing institution has set up a computing formula, the key conditions for the activation of the computing formula are determined based on relevant personal data and characteristics of the applicant, and these elemental conditions generate different dynamic computed numbers corresponding to each cardholder, which are then further used to compile product numbers, and reconverted to provide an identification card number of the consumer to enable the card issuing institution to issue a card. When an applicant submits an application, hidden input portions of the personal information, account number, and password of the applicant are set up. And there is practically no possibility of leakage or deciphering of these hidden input portions occurring.

Specifically, according to the authentication method disclosed, the present invention enables the accurate information and data of the payer identity, payee identity, and the transaction amount to be converted into a dynamic digital combination and re-transmitted (one-time operation) when a financial proceeding occurs, thereby ensuring that there is no possibility for the information and data to be copied, while still allowing for accurate identification. The method effectively transforms current financial proceedings in which there are the risks of personal information being easily stolen or made fraudulent use of. Hence, the present invention not only provides low cost of use, is very easy to implement, and extremely competitive, but also improves the shortcomings of the prior art which only enables identity authentication. The present invention is widely applicable for use in financial proceedings with credit cards, cash cards, personal accounts, check clearing, remittances, and the like, and uses a relatively more secure, faster, and convenient identity authentication method to reduce operating costs of the financial institution.

The technical contents of the present invention and technical features thereof are as disclosed above. However, it is of course to be understood that the embodiments described herein are merely illustrative of the principles of the invention and that a wide variety of modifications thereto may be effected by persons skilled in the art without departing from the spirit and scope of the invention as set forth in the following claims.

1. A fully-automatic digital electronic payment transaction identity authentication method with high security, wherein a cardholder first applies to a card issuing institution for a debit card set up with a chip, a computing formula recognized and confirmed by the card issuing institution is built into the chip of each chip debit card; when the cardholder uses the chip debit card to carry out a financial transaction, a financial transactions system inserts the collecting account number, payment amount, identification number for the financial transaction proceeding at that instance, and an identification card number of the cardholder of the debit card into a computing formula built into the chip debit card, corresponding values produced by the computing formula are then combined with at least one set of hidden numerals input by the cardholder when making a purchase, a dynamic combination code converted from a set of information and data including the payment account number, the collecting account number, and consumption amount for the financial transaction proceeding at that instance is obtained and re-transmitted; the dynamic combination code serves as a basis for the card issuing institution to authenticate the identity of the cardholder, thereby the risk of copying of personal information and account number of the cardholder, and fraudulent use thereof is reduced.

2. The fully-automatic digital electronic payment transaction identity authentication method with high security according to claim 1, wherein when the cardholder applies to the card issuing institution for a debit card set up with the chip, at the same time the cardholder is able to apply to set up a reserve card that is limited to transfer of accounts to the chip debit card, thereby enabling the cardholder to choose to retain the majority of their money in the reserve card, and store a limited amount of money in the chip debit card for use when the cardholder goes out.

3. The fully-automatic digital electronic payment transaction identity authentication method with high security according to claim 1, wherein the chip debit card is further set up with an activation password to strengthen the function to authenticate the identity of the cardholder.

4. The fully-automatic digital electronic payment transaction identity authentication method with high security according to claim 2, wherein the chip debit card is further set up with an activation password to strengthen the function to authenticate the identity of the cardholder.

5. The fully-automatic digital electronic payment transaction identity authentication method with high security according to claim 1, wherein the cardholder sets up the identification card number of the cardholder to automatically register in the financial transactions system when using the chip debit card, or sets up the debit card for the identification card number to input anew into the financial transactions system every time the chip debit card is used.

6. The fully-automatic digital electronic payment transaction identity authentication method with high security according to claim 2, wherein the cardholder sets up the identification card number of the cardholder to automatically register in the financial transactions system when using the chip debit card, or sets up the debit card for the identification card number to input anew into the financial transactions system every time the chip debit card is used.

7. The fully-automatic digital electronic payment transaction identity authentication method with high security according to claim 1, wherein the cardholder further sets up characteristics of the cardholder that are used to implement checking and verification when a high payment limit is made or when a password input error occurs.

8. The fully-automatic digital electronic payment transaction identity authentication method with high security according to claim 2, wherein the cardholder further sets up characteristics of the cardholder that are used to implement checking and verification when a high payment limit is made or when a password input error occurs.

9. The fully-automatic digital electronic payment transaction identity authentication method with high security according to claim 7, wherein the characteristics of the cardholder are chosen to be at least a photo, height, weight, feature of the cardholder's appearance, telephone number, or the cardholder's license number.

10. The fully-automatic digital electronic payment transaction identity authentication method with high security according to claim 8, wherein the characteristics of the cardholder are chosen to be at least a photo, height, weight, feature of the cardholder's appearance, telephone number, or the cardholder's license number.

11. The fully-automatic digital electronic payment transaction identity authentication method with high security according to claim 1, wherein at least one set of the hidden numerals is the account number password for the chip debit card.

12. The fully-automatic digital electronic payment transaction identity authentication method with high security according to claim 2, wherein at least one set of the hidden numerals is the account number password for the chip debit card.
